(19) United States
(12) Patent Application Publication
(10) Pub. No.: US 2014/0369222 A1
(43) Pub. Date: Dec. 18, 2014

(54) METHOD FOR ESTIMATING NETWORK JITTER IN APPARATUS FOR TRANSMITTING CODED MEDIA DATA

(71) Applicant: Electronics and Telecommunications Research Institute, Daejeon (KR)

(72) Inventors: Chang Ki Kim, Daejeon (KR); Tae Jung Kim, Cheongju-si Chungcheongbuk-do (KR); Jeong Ju Yoo, Daejeon (KR); Young Ho Jeong, Daejeon (KR); Jin Woo Hong, Daejeon (KR); Kwang Deok Seo, Wonju-si Gangwon-do (KR)

(73) Assignee: Electronics and Telecommunications Research Institute, Daejeon (KR)

(21) Appl. No.: 14/374,292

(22) PCT Filed: Jan. 28, 2013
(86) PCT No.: PCT/KR13/00681

§ 371 Date: Jul. 24, 2014

(30) Foreign Application Priority Data
Jan. 26, 2012 (KR) 10-2012-0007988
Jan. 28, 2013 (KR) 10-2013-0009251

(51) Int. Cl. H04L 12/26; H04L 29/06

(52) U.S. Cl. CPC H04L 43/087; H04L 29/06517; H04L 43/106
USPC 370/252

(57) ABSTRACT

The present invention relates to a method for estimating network jitter, which has the effect of more precisely estimating network jitter by using time information corresponding to a transmission time, which is transmitted from a transport layer in a transmitting end to a receiving end.

### CROSS-REFERENCE TO RELATED APPLICATIONS

This application claims the benefit of priority of Korean Patent Application No. 10-2012-0007988 filed on Jan. 26, 2012 and Korean Patent Application No. 10-2013-0009251 filed on Jan. 28, 2013, all of which is incorporated by reference in its entirety herein.

### TECHNICAL FIELD

The present invention relates to a method for estimating network jitter, and more particularly, to a method for estimating jitter in a system for transporting coded media data via a heterogeneous IP network.

### BACKGROUND ART

The MPEG-2 system has standardized MPEG-2 transport stream (TS) technology as a standard for functions such as packetization, synchronization, multiplexing, and the like, required for transporting audio video (AV) contents in a broadcast network. The MPEG-2 TS technology has been currently widely used. However, the MPEG-2 TS is ineffective in a new environment in which all the networks are based on Internet protocol (IP).

Thus, a new media transmission technology is required in a system for transporting coded media data via a heterogeneous IP network in consideration of a new media transmission environment and an anticipated media transmission environment in the future.

FIG. 4 illustrates a structure of an RTP packet. A method for estimating jitter provided in an RTP estimates jitter by utilizing an RTP timestamp. Equation 1 and Equation 2 represent equations used to calculate jitter adopted in the existing RTP.

D(i,j)=(Rj−Ri)−(Sj−Si)=(Rj−Sj)−(Ri−Si) [Equation 1]

J(i)=J(i−1)+(|D(i−1,i)|−J(i−1))/16 [Equation 2]

In Equation 1, Si and Sj indicate RTP time stamps of an RTP packet i and packet j, and Ri and Rj indicate a time of arrival of the RTP packet i and the packet j in a receiver. Thus, D(i, j) indicates results obtained by measuring time differences between sampling instants and arrival time of neighboring packets in the receiver. Equation 2 represents a process of iteratively calculating and updating jitter values with respect to arriving packets by utilizing D(i, j) value.

In this case, however, the RTP timestamp used in Equation 1 refers to a time corresponding to a sampling instant of a media frame, so it cannot accurately indicate a delivery instant corresponding to an instant at which a packet is transported. FIG. 5 illustrates a process of generating an RTP packet of an RTP packet transmission system utilizing time information corresponding to a media sampling instant, as an RTP timestamp value.

An accurate jitter value should be calculated based on a time required for transmission affected purely by a transmission state of a network while a packet is being transported via a network. In general, an irregular temporal gap exists between a sampling instant and a delivery instant at which a packet is actually transported. Due to such an irregular temporal gap, utilization of an RTP timestamp value indicating a sampling instant as an instant indicating a delivery instant results in an inaccurate jitter calculation.

FIG. 6 illustrates an example of an MPEG media transmission service exposed to such a problem. In case of a ultra high definition (UHD) video, it has very high resolution, so a data size after compression may be very large. Thus, it may be impossible to map a single video frame in a single transmission packet and transport the same. In this case, a single video frame having the same sampling instant is fragmented into several parts, and each of the divided parts is included in an individual packet and transported. FIG. 6 illustrates a case in which a UHD video frame is divided into three parts and included in individual packets and transported. In particular, the divided parts may undergo an application layer forward error correction (AL-FEC), interleaving, or the like, in an application layer so as to be robust to a network error. Due to the application layer processing, the transmission order of the divided parts may be reversed, or a delayed time of the divided parts up to an instant at which an actual transmission is made may vary. Thus, in FIG. 6, although the same sampling instant “3000” is assigned to the three divided packets, but the packets have different delivery instants of “3100”, “3200”, and “3300”, respectively. In this case, time information required for accurately calculating jitter is values such as “3100”, “3200”, and “3300” corresponding to delivery instants, but in the existing method, the value “3000” is applied for calculation.

As a result, the RTP timestamp used for calculating jitter in the existing RTP, which corresponds to a sampling instant, does not represent an accurate delivery instant, so it is inappropriate for accurately calculating jitter.

### DISCLOSURE

### Technical Problem

The present invention provides a method for more accurately estimating network jitter in a system for transporting coded media data in a heterogeneous network.

### Technical Solution

In an aspect, a method for transporting media data in an apparatus for transporting coded media data, includes: generating an MPEG media transport: (MMT) packet by using a timestamp indicating an instant at which coded media data and the MMT transport packet are transported.

The method may further include: receiving a media fragment unit (MFU) having a format agnostic to a particular media codec from a media codec layer; generating a media processing unit (MPU) by using the MFU; encapsulating the generated MPU to generate an MMT asset; encapsulating the generated MMT asset to generate an MMT package; and receiving the generated MMT package and generating MMT payload, wherein in the generating of the MMT transport packet, the MMT transport packet is generated by using the MMT payload.

The timestamp may indicate an instant at which a first bit of the MMT transport packet is to be transported.

The method may further include: transporting the MMT transport packet.

In another aspect, an apparatus for transporting media data for transporting coded media data, includes: an MMT transport packet generation unit configured to generate an MMT transport packet by using a timestamp indicating an instant at which coded media data and the MMT transport packet are to be transported.

The apparatus may further include: a media fragment generation unit receiving a media fragment unit (MFU) having a format agnostic to a particular media codec from a media codec layer; a media processing unit (MPU) generation unit configured to generate an MPU by using the MFU; an MMT asset generation unit configured to encapsulate the generated MPU to generate an MMT asset; an MMT package generation unit configured to encapsulate the generated MMT asset to generate an MMT package; an MMT payload generation unit configured to receive the generated MMT package and generate MMT payload, wherein the MMT transport packet generation unit generates an MMT transport packet by using the MMT payload and the timestamp.

The MMT transport packet generation unit may store the timestamp in a head part of the MMT transport packet.

The timestamp may indicate an instant at which a first bit of the MMT transport packet is to be transported.

The apparatus may further include: a delivery unit configured to deliver the MMT transport packet.

In another aspect, a method for estimating network jitter in an apparatus for receiving coded media data, includes: calculating network jitter by using a time stamp generated, by an MMT transport packet generation unit of a media data transporting apparatus, in an MMT transport packet to indicate an instant at which media data is transported and an instant at which the media data is received by the media data receiving apparatus.

The method for estimating network jitter may further include: receiving, by the media data receiving apparatus, the MMT transport packet; and obtaining, by the media data receiving apparatus, an instant at which the MMT transport packet was received, wherein the instant at which the media data was received is an instant at which the MMT transport packet was received.

The timestamp may indicate an instant at which a first bit of the MMT transport packet was transported from the media data transporting apparatus.

In the calculating of network jitter, jitter values may be iteratively calculated to be updated by using a time difference between a delivery instant and a reception instant of at least one received MMT transport packet.

In the calculating of network jitter, network jitter may be calculated by using J_{MMT}(i)=J_{MMT}(i−1)+(|D_{MMT}(i−1,i)|−J_{MMT}(i−1))/16, wherein D_{MMT}(i, j) indicates a difference in time interval between a delivery instant and a reception instant of MMT transport packets i and j, and J_{MMT}(i) indicates network jitter of ith transport packet.

The difference in time interval between the delivery instant and the reception instant may be calculated by subtracting a difference between a delivery instant of a first MMT transport packet and a second MMT transport packet from a difference between a reception instant of the first MMT transport packet and a reception instant of the second MMT transport packet.

In another aspect, an apparatus for estimating network jitter in an apparatus for receiving coded media data, including: a network jitter estimating unit configured to calculate network jitter by using a time stamp generated by an MMT transport packet generation unit of a media data transporting apparatus in an MMT transport packet to indicate an instant at which media data is transported and an instant at which the media data was received by the media data receiving apparatus.

The network jitter estimating apparatus may further include: a reception unit configured to receive the MMT transport packet and obtaining an instant at which the MMT transport packet was received.

The time stamp may indicate an instant at which a first bit of the MMT transport packet was transported from the media data transporting apparatus.

The network jitter estimating unit may iteratively calculate and update jitter values by using a time difference between the delivery instant and the reception instant.

The network jitter estimating unit may calculate network jitter by using J_{MMT}(i)=J_{MMT}(i−1)+(|D_{MMT}(i−1,i)|−J_{MMT}(i−1))/16, wherein D_{MMT}(i, j) indicates a difference in time interval between a delivery instant and a reception instant of MMT packets i and j, and J_{MMT}(i) indicates network jitter of ith transport packet.

The difference in time interval between the delivery instant and the reception instant may be calculated by subtracting a difference between a delivery instant of a first MMT transport packet and a second MMT transport packet from a difference between a reception instant of the first MMT transport packet and a reception instant of the second MMT transport packet.

In another aspect, an MMT transport packet structure used for transporting coded media data includes a time stamp generated by an MMT transport packet generation unit of a coded media data transporting apparatus to indicate time information of an instant at which an MMT transport packet is transported.

The time stamp may indicate an instant at which a first bit of the MMT transport packet was transported by the media data transporting apparatus.

### Advantageous Effects

In the case of the network jitter estimating method according to an embodiment of the present invention, since a transmission side, which delivers an MMT transport packet generated as coded media data, generates information regarding a delivery instant of an MMT packet in an MMT layer that generates an MMT transport packet, includes the same in an MMT transport packet, and delivers the MMT transport packet, network jitter can be more accurately estimated.

### DESCRIPTION OF DRAWINGS

FIG. 1 is a conceptual view illustrating an MMT layer structure.

FIG. 2 is a conceptual view illustrating a format of unit information (or data or packet) used in each layer of the MMT layer structure.

FIG. 3 is a conceptual view illustrating a configuration of an MMT package.

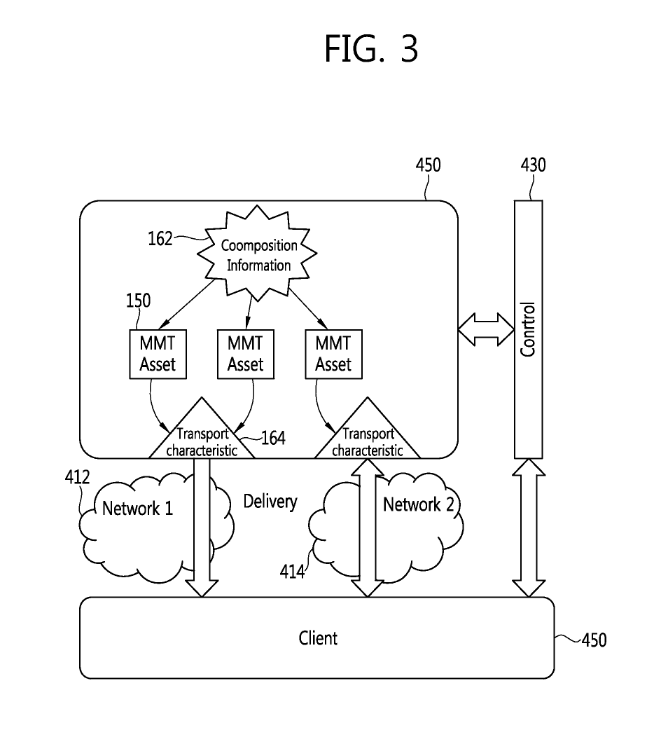

FIG. 4 is a view illustrating a structure of an RTP packet.

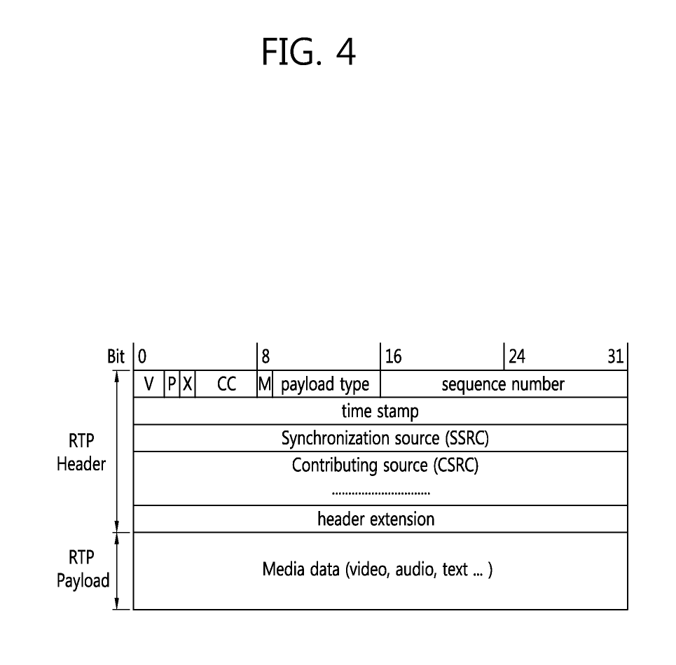

FIG. 5 is a view illustrating an RTP packet generation process of an RTP packet transporting system in which time information corresponding to a media sampling instant is used as an RTP time stamp value.

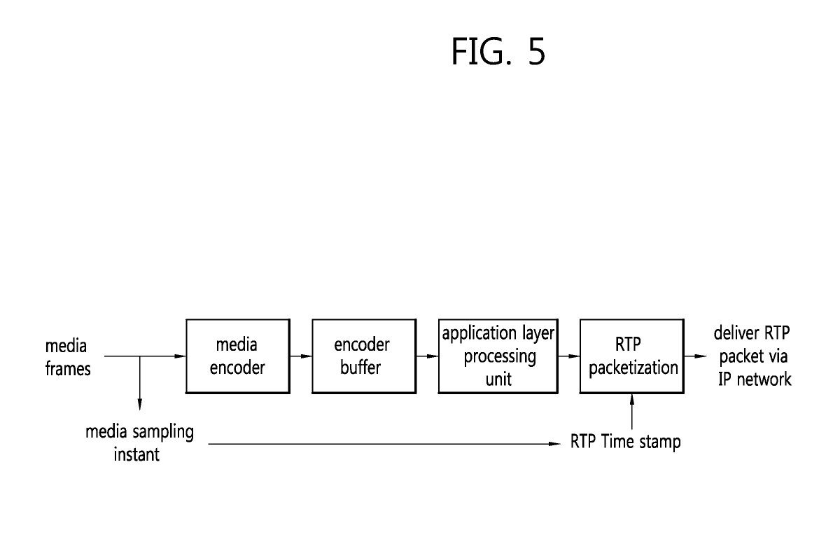

FIG. 6 is a view illustrating an example in which a single high resolution video frame is divided into several packets to have different delivery instants.

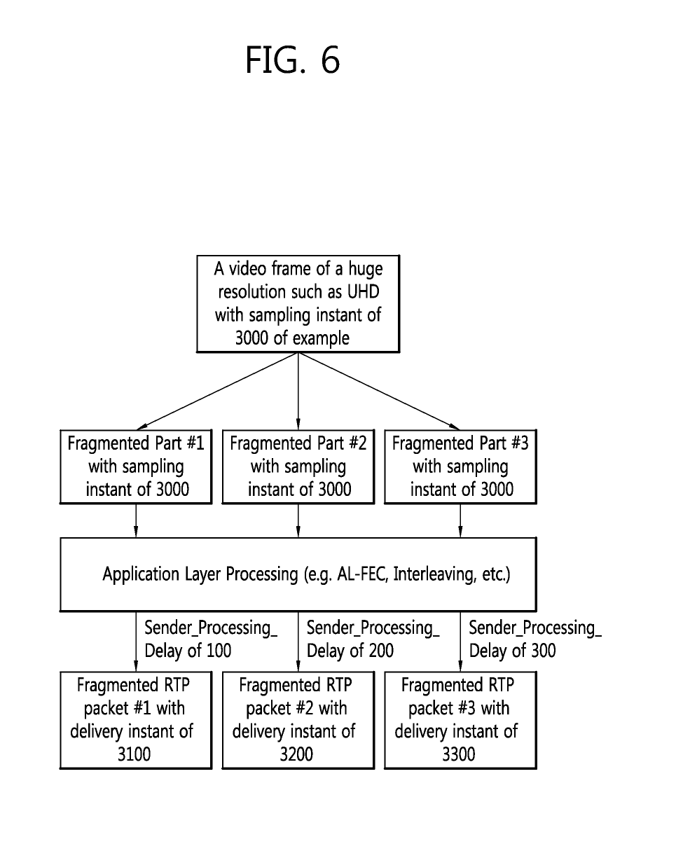

FIG. 7 is a block diagram of a system for transporting coded media data according to an embodiment of the present invention.

FIG. 8 is a block diagram of an apparatus for transporting coded media data according to an embodiment of the present invention.

FIG. 9 is a view illustrating a sequential operation of the apparatus for transporting coded media data according to an embodiment of the present invention.

FIG. 10 is a block diagram of an apparatus for receiving coded media data according to an embodiment of the present invention.

FIG. 11 is a view illustrating a sequential operation of the apparatus for receiving coded media data according to an embodiment of the present invention.

FIG. 12 is a view illustrating a process of generating an MMT transport packet by an apparatus for receiving coded media data according to an embodiment of the present invention by including delivery instant information in a header of an MMT packet.

FIG. 13 is a flow chart illustrating a method for estimating network jitter in a system for transporting coded media data according to an embodiment of the present invention.

FIG. 14 is a view illustrating a header structure of an MMT transport packet according to an embodiment of the present invention.

FIG. 15 is a view illustrating a header structure of an MMT transport packet according to an embodiment of the present invention.

FIG. 16 is a view illustrating semantics of an MMT transport packet header according to an embodiment of the present invention.

### MODE FOR INVENTION

The present invention may be embodied in many different forms and may have various embodiments, of which particular ones will be illustrated in drawings and will be described in detail.

However, it should be understood that the following exemplifying description of the invention is not meant to restrict the invention to specific forms of the present invention but rather the present invention is meant to cover all modifications, similarities and alternatives which are included in the spirit and scope of the present invention.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. The term “and/or” encompasses both combinations of the plurality of related items disclosed and any item from among the plurality of related items disclosed.

It will be understood that when an element is referred to as being “connected with” another element, it can be directly connected with the other element or intervening elements may also be present. In contrast, when an element is referred to as being “directly connected with” another element, there are no intervening elements present.

The terms used in the present application are merely used to describe particular embodiments, and are not intended to limit the present invention. An expression used in the singular encompasses the expression of the plural, unless it has a clearly different meaning in the context. In the present application, it is to be understood that the terms such as “including” or “having,” etc., are intended to indicate the existence of the features, numbers, operations, actions, components, parts, or combinations thereof disclosed in the specification, and are not intended to preclude the possibility that one or more other features, numbers, operations, actions, components, parts, or combinations thereof may exist or may be added.

Unless otherwise defined, all terms used herein, including technical or scientific terms, have the same meanings as those generally understood by those with ordinary knowledge in the field of art to which the present invention belongs. Such terms as those defined in a generally used dictionary are to be interpreted to have the meanings equal to the contextual meanings in the relevant field of art, and are not to be interpreted to have ideal or excessively formal meanings unless clearly defined in the present application.

Meanings of terms are defined as follows.

A system for transporting coded media data through a heterogeneous IP network is referred to as an MPEG media transport (MMT) system.

A content component or media component is defined as a single type of media or a subset of a single type of media. For example, the content component or media component may be a video track, movie subtitles, a video enhancement layer.

The content is defined as a set of contents components and may be, for example, movie, song, or the like.

Presentation is defined as an operation performed by one or more devices to allow a user to experience (e.g., enjoy a movie) one contents component or one service.

Service is defined as one or more contents components transported for presentation or storage.

Service information is defined as meta data describing one service and characteristics and components of the service.

Access unit (AU) is the smallest data entity that may have time information as an attribute.

When coded media data for which time information for decoding presentation is not designated is related, the AU is not defined.

MMT asset is a logical data entity configured as at least one MPU together with the same MMT asset ID or configured as a particular data clod together with a format defined in a different standard. MMT asset is the largest data unit to which the same composition information and delivery characteristics are applied.

MMT asset delivery characteristics (MMT-ADC) is description related to QoS requirements for transporting an MMT asset. MMT-ADC is expressed such that a particular transmission environment is not known.

MMT composition information (MMT CI) describes spatial and temporal relationship between MMT assets.

A media fragment unit (MFU) is a general container which is agnostic to any particular codec and accommodates coded media data independently consumed by a media decoder. The MFU accommodates information that may be used in a transport layer having a size smaller than or equal to that of an AU.

MMT package is a collection of logically structured data, which is comprised of at least one MMT asset, MMT-composition information, MMT-asset delivery characteristics, and descriptive information.

MMT packet is a format of data generated or consumed by an MMT protocol.

MMT payload format is a format for payload of an MMT signaling message or an MMT package to be transported by an MMT protocol or an Internet application layer protocol (e.g., an RTP).

Media processing unit (MPU) is a general container which is agnostic to any particular media codec and accommodates information regarding at least one AU and additional transmission and consumption. For non-timed data, MPU accommodates a part of data not belonging to an AU range. MPU is coded media data which is complete and independently processed. In this context, processing refers to encapsulation or packetization into an MMT package for transmission.

Non-timed data defines every data element consumed without specifying time. Non-timed data may have a time range at which data may be executed or starts.

Timed data defines a data element associated with a particular time for decoding and presentation.

Media data refers to a data element including both non-timed data and time data.

Media unit refers to a container including a media fragment unit (MFU) or a media processing unit (MPU).

Hereinafter, an embodiment of the present invention will be described in detail with reference to the accompanying drawings. In describing the present invention, in order to facilitate overall understanding, like reference numerals are used for the same elements and a repeated description of the same elements will be omitted.

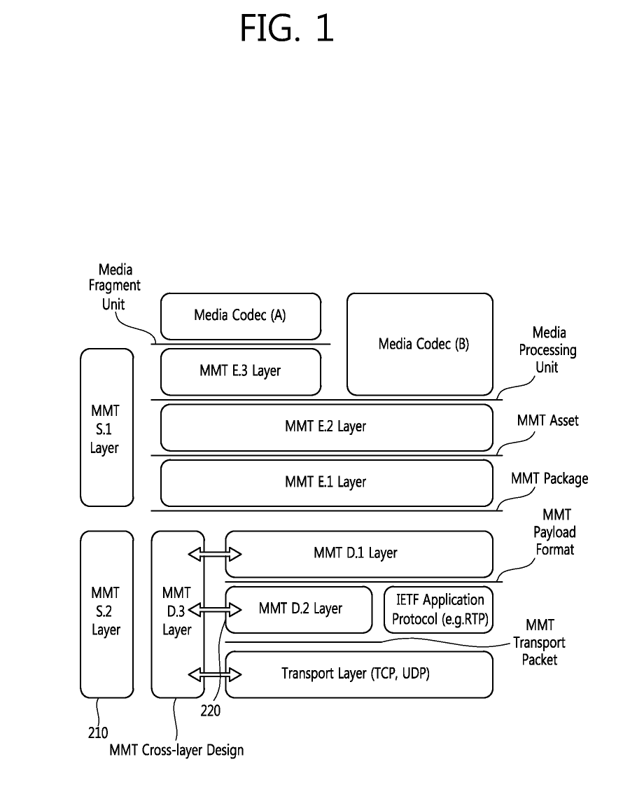

FIG. 1 is a conceptual view illustrating an MMT layer structure.

Referring to FIG. 1, an MMT layer includes an encapsulation layer, a delivery layer, and an S layer. The MMT layer operates above a transport layer.

An encapsulation layer (E-layer) may handle functions of, for example, packetization, fragmentation, synchronization, multiplexing, and the like, of transported media.

An encapsulation functional area defines a logical structure of a format of data units to be processed by an entity in compliance with media contents, MMT package, and MMT. In order to provide essential information for an adaptive transmission, the MMT package clarifies components including media contents and relationships therebetween. A format of data units is defined to encapsulate media coded to be stored or transported as payload of a transport protocol or easily converted therebetween.

As illustrated in FIG. 1, the E-layer may include an MMT E.1 layer, an MMT E.2 layer, and an MMT E.3 layer.

The E.3 layer encapsulates a media fragment unit (MFU) provided from the media codec (A) layer to generate a media processing unit (MPU).

Coded media data from a higher layer is encapsulated into an MFU. A type and a value of coded media may abstract an MFU such that it can be generally used in a particular codec technique. This allows a lower layer to process an MFU without accessing encapsulated coded media. The lower layer may retrieve requested coded media data from a network or a buffer of a repository and deliver the same to a media decoder. The MFU has an information media part unit sufficient for performing the above operation.

The MFU may have a format which can carry a data unit independently consumed in a media decoder and is agnostic to a certain particular coded. The MFU may be, for example, a picture or a slice of a video.

An MFU of a plurality of MFUs of a group that can be independently transported and decoded generates an MPU. Independently transmittable and executable non-timed media may also generate an MPU. The MPU describes an internal structure such as an arrangement and a pattern of an MPU allowing for a fast access to an MFU and partial consumption thereof.

The E.2 layer encapsulates the MPU generated in the E.3 layer to generate an MMT asset.

The MMT asset is a data entity including one or a plurality of MPUs from a single data source, and is a data unit including defined composition information (Cl) and transport characteristics (TC). The MMT asset is multiplexed by an MMT payload format and transported by an MMT protocol. The MMT asset may correspond to packetized elementary streams, and may correspond to, for example, a video, an audio, program information, an MPEG-U, a widget, an JPEG image, an MPEG 4 file format, an M2TS (MPEG transport stream), or the like.

The E.1 layer encapsulates the MMT asset generated in the E.2 layer too generate an MMT package.

The MMT asset is packaged together with a different functional region, i.e., a transmission region and a signal region, or may be separately packaged together with MMT composition information for a later response of the same user experience. The MMT package is also packaged together with delivery characteristics of selecting an appropriate transmission method for each MMT asset in order to satisfy quality of experience of an MMT asset.

The MMT package may include one or a plurality of MMT assets together with composition information and additional information such as transport characteristics. The composition information includes information regarding a relationship between MMT assets, and when one contents includes a plurality of MMT packages, the composition information may further include information for indicating a relationship between a plurality of MMT packages. The transport characteristics may include transport characteristics information required for determining a delivery condition of an MMT asset or an MMT packet. The transport characteristics may include, for example, a traffic description parameter and a QoS descriptor. The MMT package may correspond to a program of an MPEG-2 TS.

The delivery layer may perform, for example, network flow multiplexing of media transported via a network, network packetization, QoS control, or the like.

The delivery functional area defines an application layer protocol and a format of payload. In the present embodiment, the application layer protocol provides strengthened features for delivering an MMT package in comparison to the related art application layer protocol for transporting multimedia including multiplexing. The payload format is defined to deliver coded media data irrespective of a media type or encoding method.

As illustrated in FIG. 1, the D-layer may include an MMT D.1 layer, an MMT D.2 layer, and an MMT D.3 layer.

The D.1 layer generates an MMT payload format upon receiving an MMT package generated in the E.1 layer. The MMT payload format is a payload format for transporting an MMT asset and transporting information for consumption based on an MMT application protocol or an existing application transport protocol such as an RTP. The MMT payload may include a fragment of an MFU together with information such as AL-FEC.

The D.2 layer generates an MMT transport packet or an MMT packet upon receiving an MMT payload format generated in the D.1 layer. The MMT transport packet or the MMT packet is a data format used for an application transport protocol for an MMT.

The D.3 layer supports QoS by providing a function of exchanging information between layers by a cross-layer design. For example, the D.3 layer may perform QoS control by using a QoS parameter of a MAC/PHY layer.

The S layer performs a signaling function. For example, the S layer may perform a signaling function for a session initialization/control/management of transported media, a server-based and/or client-based trick mode, service discovery, synchronization, or the like.

The signaling functional area defines a format of messages for managing delivery and consumption of an MMT package. The message for managing consumption is used to deliver a structure of an MMT package and the message for managing delivery is used to deliver a structure of a payload format and a configuration of a protocol.

As illustrated in FIG. 1, the S layer may include an MMT S.1 layer and an MMT S.2 layer.

The S.1 layer may perform service discovery, media session initialization/termination, media session presentation/control, an interface function with a delivery (D) layer and an encapsulation (E) layer, and the like. The S.1 layer may define a format of control messages between applications for a media presentation session management.

The S.2 layer may define a format of control messages exchanged between delivery end-points of the D layer regarding a flow control, delivery session management, a delivery session monitoring, an error control, and a hybrid network synchronization control.

The S.2 layer may include signaling for delivery session establishment and release, delivery session monitoring, a flow control, an error control, a resource reservation with respect to a set delivery session, and synchronization in a complex delivery environment, and signaling for adaptive delivery, in order to support an operation of a delivery layer. The S.2 layer may provide signaling required between a sender and a receiver. Namely, the S.2 layer may provide signaling required between a sender and a receiver in order to support an operation of a delivery layer as mentioned above. Also, the S.2 layer may handle an interface function with a delivery layer and an encapsulation layer.

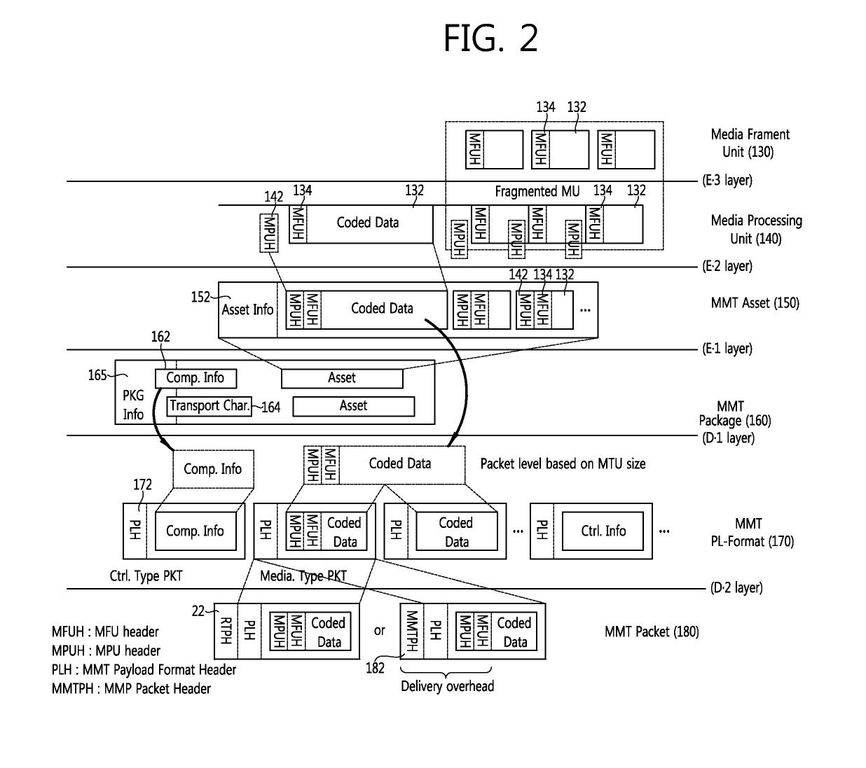

FIG. 2 is a conceptual view illustrating a format of unit information (or data or a packet) used in each layer of the MMT layer structure.

A media fragment unit (MFU) 130 may include coded media fragment data 132 and a media fragment unit header (MFUH) 134. The MFU 130 may carry the smallest data unit which has an independently general container format and may be consumed independently in a media decoder. The MFUH 134 may include additional information such as media characteristics, e.g., loss tolerance. The MFU 130 may be, for example, a picture or a slide of a video.

The MFU may define a format of encapsulating a part of AU in a transport layer in order to perform adaptive transmission within a range of the MFU. The MFU may be used to deliver a certain format of coded media such that a part of an AU is independently decoded or discarded.

The MFU may have an identifier for identifying one MFU from other MFUs and have general relationship information between MFUs within a single AU. A dependent relationship between MFUs in a single AU may be described and relevant priority of an MFU may be described as a part of such information. The information may be used to handle transmission in a lower transport layer. For example, a transport layer may omit transmission of MFUs that may be discarded, in order to support QoS transmission in an insufficient bandwidth. Details of the MFU structure will be described later.

The MPU is a set of media fragment units including a plurality of media fragment units 130. The MPU may have a general container format agnostic to a particular codec and include media data equivalent to an access unit. The MPU may have a timed data unit or a non-timed data unit.

The MPU is data which is independently and completely processed by an entity following the MMT, and the processing may include encapsulation and packetization. The MPU may include at least one MFU and may have a part of data having a format defined by a different standard.

A single MPU may accommodate an integral number of at least one AU or non-timed data. For timed data, an AU may be delivered from at least one MFU, but one AU cannot be divided into a plurality of MPUs. In non-timed data, one MPU accommodates a part of non-timed data independently and completely processed by an entity in compliance with an MMT.

An MPU may be solely identified within an MMT package by a sequence number and an asset ID identifying it from a different MPU.

The MPU may have at least one arbitrary access point. A first byte of an MPU payload may start with an arbitrary access point all the time. In timed data, the foregoing fact means that decoding order of a first MFU in an MPU payload is 0 all the time. In timed data, a presentation time and decoding order of each AU may be transported to inform about a presentation time. An MPU does not have an initial presentation time of its own, and a presentation time of a first AU of one MPU may be described in composition information. The composition information may clarify a first presentation time of an MPU. Details thereof will be described later.

An MMT asset 150 is an MPU set including a plurality of MPUs. The MMT asset 150 is a data entity including a plurality of MPUs (timed or non-timed data). MMT asset information 152 includes asset packaging metadata and additional information such as a data type. The MMT asset 150 may include, for example, a video, audio, program information, MPEG-U widget, a JPEG image, MPEG 4 file format (FF), packetized elementary streams (PES), MPEG transport stream (M2TS), and the like.

The MMT asset is a logical data entity accommodating coded media data. The MMT asset may include an MMT asset head and coded media data. The coded media data may be an aggregational reference group of MPUs by the same MMT asset ID. A type of data that can be individually consumed by an entity directly connected to an MMT client may be considered as an individual MMT asset. Examples of a data type that can be considered as an individual MMT asset may include MPEG-2 TS, PES, MP4 file, MPEG-U widget package, JPEG file, and the like.

Coded media of an MMT asset may be timed data or non-timed data. The timed-data is audio-visual media data. Synchronized decoding and presentation of particular data is required at a designated time. Non-timed data is data of a data type which can be decoded and provided at an arbitrary time according to service providing or user interaction.

A service provider may incorporate MMT assets to generate a multimedia service while leaving the MMT assets in space-time axes.

An MMT package 160 is a set of MMT assets including one or more MMT assets 150. MMT assets of an MMT package may be multiplexed or concatenated like chains.

The MMT package is a container format for MMT asset and configuration information. The MMT package provides a repository of an MMT asset for an MMT program and configuration information.

An MMT program provider generates configuration information by encapsulating coded data into an MMT asset and describing a temporal and spatial layout of the MMT asset and delivery characteristics thereof. The MU and the MMT asset may be directly transported in a D.1 payload format. The configuration information may be transported by a C.1 presentation session management message. However, the MMT program provider and client permitting relay of the MMT program or a later re-use thereof stores the configuration information in the form of an MMT package.

In parsing an MMT package, the MMT program provider determines a transmission path (e.g., broadcast or broadband) for the MMT asset to be provided to a client. The configuration information in the MMT package is transported as a C.1 presentation session management message together with transmission-related information.

The client receives the C.1 presentation session management message and recognizes an available MMT program and how an MMT asset for a corresponding MMT program is received.

The MMT package may also be transported in the D.1 payload format. The MMT package is packetized in the D.1 payload format and delivered. The client receives the packetized MMT package, configures the entirety or a portion thereof, and consumes the MMT program.

Package information 165 of the MMT package 160 may include additional information such as configuration information. The configuration information may include a list of MMT assets, a package identification information, composition information 162, and transport characteristics 164. The composition information 162 includes information regarding a relationship between MMT assets 150.

Also, when one contents includes a plurality of MMT packages, the composition information 162 may further include information indicating a relationship between the plurality of MMT packages. The composition information 162 may include information regarding a temporal, spatial, adaptive relationship in the MMT packages.

Like the information helping transmission and presentation of an MMT package, the composition information in an MMT provides information regarding a spatial and temporal relationship between MMT assets in an MMT package.

An MMT-CI is a descriptive language providing such information by extending HTML5. Since HTML5 is designed to describe page-based presentation of text-based contents, an MMT-CI mainly presents a spatial relationship between sources. In order to support presentation indicating a temporal relationship between MMT assets, an MMT-CI may extend to have information regarding an MMT asset present in an MMT package like a presentation resource, temporal information determining transmission of an MMT asset, and consumption order, and an additional attribute of media elements consuming various MMT assets in HTM. Details thereof will be described later.

Transport characteristics information 164 includes information regarding transport characteristics and provide information required for determining a delivery condition of each MMT asset (or MMT packet). The transport characteristics information may include a traffic description parameter and a QoS descriptor.

Traffic description parameter may include information regarding a bit rate with respect to a media fragment unit (MFU) 130 or an MPU, priority information, and the like. The bit rare information may include information, for example, regarding whether an MMT asset has a variable bit rate (VBR) or constant bit rate (CBR), a guaranteed bit rate with respect to an MFU (or an MPU), a maximum bit rate with respect to an MFU (or an MPU). The traffic description parameter may be used to make resource reservation between a server, a client, any other components in a transmission path. For example, the traffic description parameter may include information regarding a maximum size of an MFU (or an MPU) within an MMT asset. The traffic description parameter may be periodically or aperiodically updated.

A QoS descriptor includes information for QoS controlling. For example, the QoS descriptor may include delay information and loss information. The loss information may include a loss indicator regarding whether or not a delivery loss of an MMT asset is permitted. For example, when the loss indicator is 1, it may indicate ‘lossless’, and when the loss indicator is 0, it may indicate ‘lossy’. Delay information may include a delay indicator used to discriminate sensitivity of transmission delay of an MMT asset. The delay indicator may indicate whether a type of an MMT asset is conversion, interactive, real time, or non-realtime.

One contents may include one MMT package. Or, one contents may include a plurality of MMT packages.

When one contents includes a plurality of MMT packages, composition information or configuration information indicating a temporal, spatial, and adaptive relationship among a plurality of MMT packages may be present within or outside one MMT package among MMT packages.

For example, in case of a hybrid delivery, a portion of contents components may be transported via a broadcast network and the other remaining portion of the contents components may be transported via a broadband network. For example, in case of a plurality of audiovisual (AV) streams constituting one multi-view service, one stream may be transported via a broadcast network and the other stream may be transported via a broadband network. Each AV stream may be multiplexed and individually received by and stored in a client terminal. Or, for example, a scenario in which application software such as widget is transported via a broadband network and an AV stream AV program) is delivered via an existing broadcast network may exist.

In the case of the multi-view service scenario and/or the widget scenario, the entirety of a plurality of AV streams may become a single MMT package, and in this case, one of the plurality of AV streams may be stored only in a single client terminal, storage contents becomes a part of an MMT package, the client terminal should rewrite composition information or configuration information, and the rewritten contents is a new MMT package irrespective of a server.

In the case of the multiview service scenario and/or widget scenario, each AV stream may become a single MMT package, and in this case, a plurality of MMT packages constitute single contents and recorded by MMT package unit in a storage, and composition information or configuration information indicating a relationship among MMT packages is required.

The composition information or configuration information included in a single MMT package may refer to an MMT asset of a different MMT package, or may present the exterior of an MMT package referring to the MMT package in an out-band situation.

Meanwhile, in order to information a client terminal about a path available for delivering a list of MMT assets 150 provided by the service provider and an MMT package 160, the MMT package 160 is translated into service discovery information through a control (C) layer, so an MMT control message may include an information table for a service discovery.

A server, which has fragmented multimedia contents into a plurality of segments, assigns URL information to a predetermined number of the plurality of fragmented segments, stores URL information regarding each segment in a media information file, and delivers the same to a client.

The media information file may be called various names such as ‘media presentation description (MPD)’, ‘manifest file’, or the like, according to standardization organization standardizing HTTP streaming. Hereinafter, the media information file will be designated as a media presentation description (MPD) and described.

Hereinafter, a cross layer interface (CLI) will be described.

A CLI is exchanging QoS related information between lower layers including an application layer and a MAC/PHY layer, in which a means supporting QoS is provided in a single entity. A lower layer provides upstream QoS information such as a network channel state, while an application layer provides information regarding media characteristics as downstream QoS information.

The CLI provides an interface integrated between an application layer and various network layers including IEE802.11 WiFi, IEEE 802.16 WiMAX, 3G, 4G LTE, and the like. Common network parameters of popular network standards are excerpted into a NAM parameter for static and dynamic QoS control of real-time media applications through various networks. The NAM parameter may include a bit error rate (BER) value. A BER may be measured from a PHY or a MAC layer. Also, the NAM provides identification of a lower network, an available bit rate, a buffer state, a peak bit rate, a service unit size, and a service data unit loss rate.

Two different methods may be used to provide NAM. A first method is providing an absolute value. A second method is providing a relative value. The second method may be used for the purpose of updating NAM.

An application layer provides downstream QoS information related to media characteristics with respect to a lower layer. Two types of downstream information such as MMT asset level information and packet level information exist. The MMT asset information is used to capacitor exchange and/or resource (re)allocation in a lower layer. The packet level downstream information is recorded in an appropriate field of every packet for a lower layer to allow a supported QoS level to be recognized.

The lower layer provides upstream QoS information to the application layer. The lower layer provides information regarding a network state which allows the application layer to more rapidly and accurately control QoS and changes over time. The upstream information is presented in an abstracted form to support a heterogeneous network environment. Such parameters are measured in the lower layer and read by the application layer periodically or according to a request from the MMT application.

Hereinafter, payload formats for packetizing an MMT package and application protocols will be defined.

MMT payload is defined as general payload for MMT package transmission. MMT payload is agnostic to a particular media codec used for coded media data, so any type of capsulated media such as an MPU may be packetized into payloads for application layer protocols supporting a streaming transmission of media contents. MMT payload may be used as a payload format of an RTP or MMT protocol. In addition, MMT payload may also be used to transport MMT signaling messages.

MMT payload is general payload packetizing and delivering consumed information by using MMT asset and MMT protocols or any other application layer protocol. MMT payload may be used to packetize an MPU and MMT signaling message.

MMT payload transfers at least one MPU having the same asset ID, MMT signaling message, FEC parity, and other information. MMT payload may collect a plurality of same type of data units as single payload, and divide data of a single unit into a plurality of payloads.

MMT payload may provide length information including a header and data of payload. An MMT payload header has a variable size.

An MMT protocol defines an application layer protocol supporting a streaming transmission of media contents through a heterogeneous IP network environment. The MMT protocol is an application layer protocol for transporting effectively and reliably transporting an MMT package.

The MMT protocol provides important features in transporting an MMT package, which includes protocol level multiplexing allowing various MMT assets to be transported in a single MMT data flow, a transmission timing model agnostic to a presentation time adaptive to a broad range of network jitter, and information supporting QoS.

Namely, the MMT protocol may support functions such as multiplexing, network jitter calculation, and QoS indication required for transporting contents comprised of various types of coded media data.

The MMT protocol provides a means for calculating jitter caused by a lower delivery network and generating continuous delay of a data stream, and canceling the same. Since a delivery instant field is used in a packet header, jitter can be accurately calculated even without additional signaling protocols.

Transmission of media data constrained by time is important characteristics according to temporal necessity of an MMT protocol. Preservation of timing relationships among packets of a single MMT protocol packet flow or between packets of different MMT protocol packet flows is important characteristics in an MMT environment. MMT clarifies a timing model to be used for delivering an MMT package. A delivery timing model provides a function of calculating a total amount of jitter and delay caused by an underlying transport network in delivery of MMT package. In order to synchronize clocks of transmitter and receiver, NTP may be used as stated in RFC 5905.

An apparatus for transporting coded media data according to an embodiment of the present invention uses a method of calculating jitter by utilizing a delivery instant, rather than a sampling instant, in order to accurately calculate jitter.

In the method provided by the existing RTP, a sampling instant is used to calculate network jitter, so delay instants due to various application processings generated in a transmission side before a packet is actually transported may be included in calculation of jitter. Thus, network jitter generated purely in a delivery process through a network cannot be accurately calculated. The apparatus for transporting coded media data according to an embodiment of the present invention improves inaccuracy of the jitter estimating method provided in the existing RTP to allow for more accurate jitter estimation, and allows the results to be utilized in an MMT system-based media transport service.

In a method for estimating network jitter according to an embodiment of the present invention, jitter is calculated by utilizing a delivery instant that may be provided by a transport layer of MMT. Thus, in an MMT system-based media transport service, jitter indicating variations of inter-arrival time among packets generated in a delivery process via an IP network can be accurately calculated. In a method for estimating network jitter according to an embodiment of the present invention, a transmission side of transporting an MMT packet delivers delivery instant information of an MMT packet which is to be transported to a reception side. As illustrated in FIG. 1, in consideration of a protocol structure of an MMT system in which an MMT transport packet is delivered from the D.2 layer by TCP/IP and UDP and a corresponding function, the delivery layer (D-layer) may deliver information regarding a delivery instant. In delivering an MMT packet, time information that may express a delivery instant of an MMT packet desired to be delivered is included in a header of a packet generated in the delivery layer. The time information may a time at which the MMT packet is transported from a delivery unit, and more accurately, it may be a time at which a first bit of an MMT packet is transported by a delivery unit.

Also, in the method for estimating network jitter according to an embodiment of the present invention, jitter among packets that may be generated in a delivery process in which media data is transported by using a broadcast network, as well as an IP network, may also be calculated. The broadcast network may be, for example, 8-VSB. In this case, the D.2 layer may directly deliver an MMT transport packet to the broadcast network, rather than an IP network. Also, in the case of using a broadcast network, the method for estimating network jitter according to an embodiment of the present invention may also be performed by using an MMT transport packet as described hereinafter, but a transport stream (TS) packet may also be generated in the same manner as the MMT transport packet includes a unique delivery instant. Here, the TS packet may be generated by a TS packet generation unit, rather than an MMT transport packet generation unit, and the TSS packet generation unit may generate a TS packet such that it includes a delivery instant thereof, and the following content may be applied thereto.

Equation 3 serves to calculate a difference D_{MMT}(i, j) in a time interval between a delivery instant and an arrival instant of MMT transport packets. In order to calculate the difference between packet intervals of an MMT transport packet pair i and j, Equation 3 may be expressed as follows.

D_{MMT}(i,j)=(Rj−Ri)−(T_{D,j}−T_{D,i})=(Rj−T_{D,j})−(Ri−T_{D,i}) [Equation 3]

T_{D,i} and T_{D,j} are values present in an MMT packet header, which are delivery time instances of MMT packet i and packet j, respectively. Ri and Rj are time instances at which the MMT packet i and the packet j arrive an MMT receiver. Namely, T_{D,i} and T_{D,j} indicate delivery instants of the MMT packet i and the packet j, respectively, and Ri and Rj indicate arrival instants of the MMT packet i and the packet j in the reception side.

Meanwhile, MMT encapsulation data may be transported through D-layer packetization of MMT or may be transported through existing RTP packetization. Thus, in order to maintain compatibility with the jitter calculation method utilized in the existing RTP, jitter J_{MMT(i)} between arrivals defined by mean dispersion of difference in packet intervals may be continuously calculated by using Equation 4 shown below as respective MMT packets i are received.

J_{MMT}(i)=J_{MMT}(i−1)+(|D_{MMT}(i−1,i)|−J_{MMT}(i−1))/16 [Equation 4]

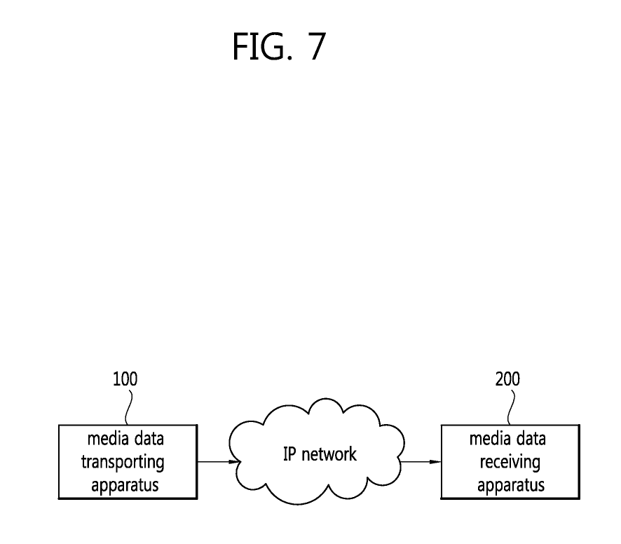

FIG. 7 is a block diagram of a system for transporting coded media data according to an embodiment of the present invention. The system for transporting coded media data according to an embodiment of the present invention may include a media data transporting apparatus 100 and a media data receiving apparatus 200, and the media data transporting apparatus 100 delivers coded data to the media data receiving apparatus via an IP network.

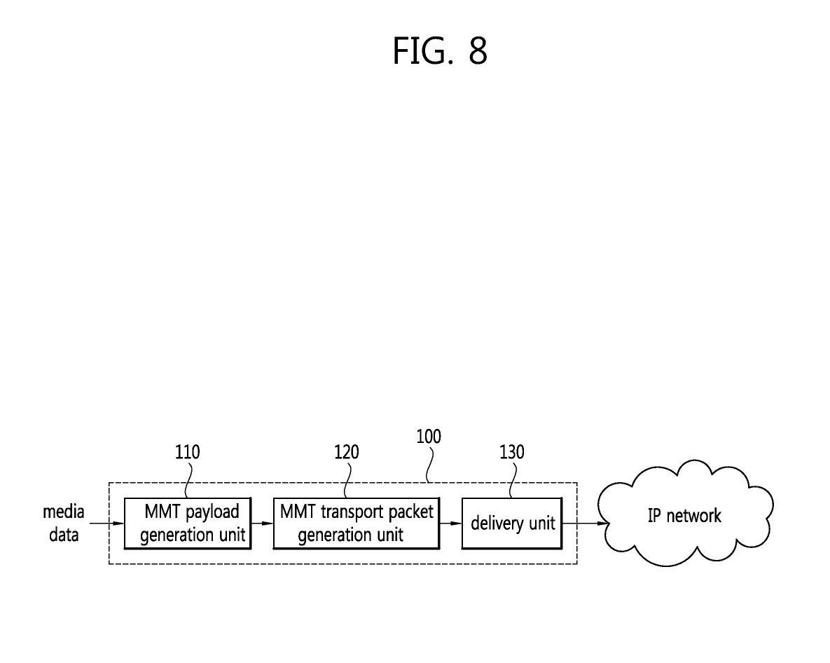

FIG. 8 is a block diagram of an apparatus for transporting coded media data according to an embodiment of the present invention. An apparatus 100 for transporting coded media data according to an embodiment of the present invention may include an MMT payload generation unit 110, an MMT transport packet generation unit 120, and a delivery unit 130.

The MMT payload generation unit 110 receives media data and generates the foregoing MMT payload. The MMT payload generation unit 110 delivers the generated MMT payload to the MMT transport packet generation unit 120. Upon receiving the MMT payload, the MMT transport packet generation unit 120 adds an MMT transport packet header thereto to generate an MMT transport packet. The MMT transport packet header may include delivery instant information. The MMT transport packet generation unit 120 delivers the generated MMT transport packet to the delivery unit 130. The delivery unit 130 delivers the MMT transport packet received from the MMT transport packet generation unit 120 to the media data receiving apparatus 200 via an IP network. The delivery unit may correct the delivery instant information to an instant at the time of delivery in the MMT transport packet, and deliver the same.

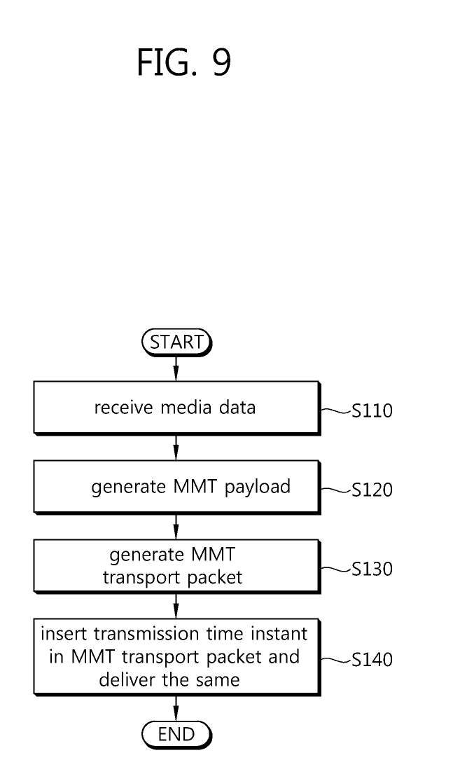

FIG. 9 is a view illustrating sequential operation of the apparatus for transporting coded media data according to an embodiment of the present invention. First, the MMT payload generation unit 110 receives media data (S110). Next, the MMT payload generation unit 110 generates an MMT payload by using the received media data. Thereafter, the MMT payload generation unit 110 generates an MMT transport packet by using the MMT payload and an MMT transport packet header (S130). The MMT payload generation unit 110 may use a time stamp field indicating delivery start information in the MMT transport packet header. The MMT transport packet generation unit 110 may insert delivery instant information into the MMT transport packet header to generate an MMT transport packet. Thereafter, the delivery unit 130 inserts a delivery time instant as delivery instant information into the MMT transport packet and delivers the same (S140). Rather than correcting the delivery instant information in the MMT transport packet, the delivery unit 130 may maintain the delivery instant information, which was inserted by the MMT transport packet generation unit 130, and deliver the same.

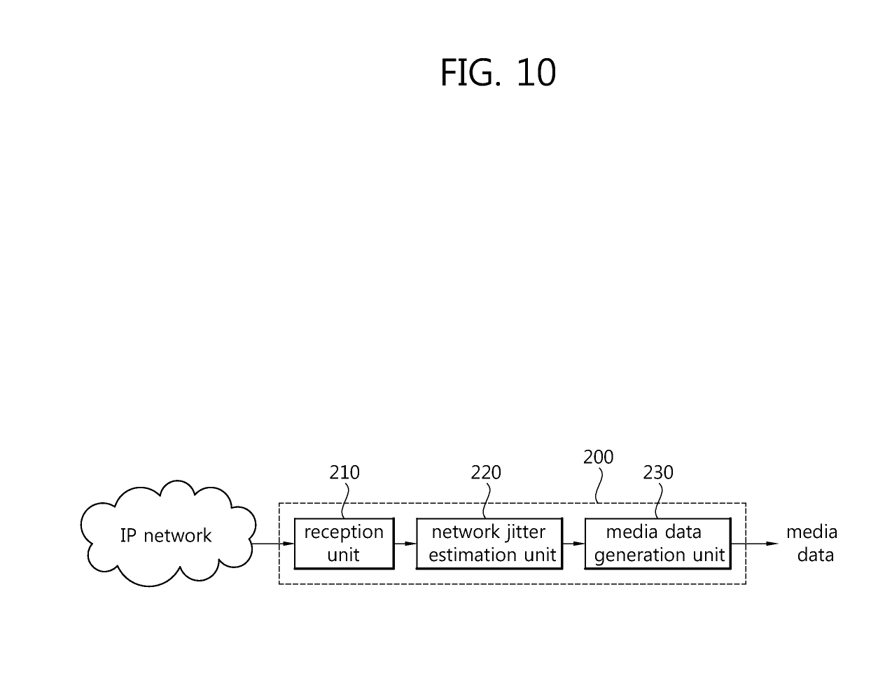

FIG. 10 is a block diagram of an apparatus for receiving coded media data according to an embodiment of the present invention. The apparatus for receiving coded media data according to an embodiment of the present invention includes a reception unit 210, a network jitter estimation unit 220, and a media data generation unit 230.

The reception unit 210 may receive an MMT transport packet from the media data transporting apparatus via the IP network. The reception unit 210 may measure an instant at which the MMT transport packet is received. The network jitter estimation unit 220 estimates network jitter. The network jitter estimation unit 220 may directly measure a reception instant of the MMT transport packet. The network jitter estimation unit 220 may estimate network jitter by using an instant at which the MMT transport packet was received and the delivery instant information of the MMT transport packet stored in a header of the MMT transport packet as described above. The media data generation unit 230 may generate media data from the MMT transport packet.

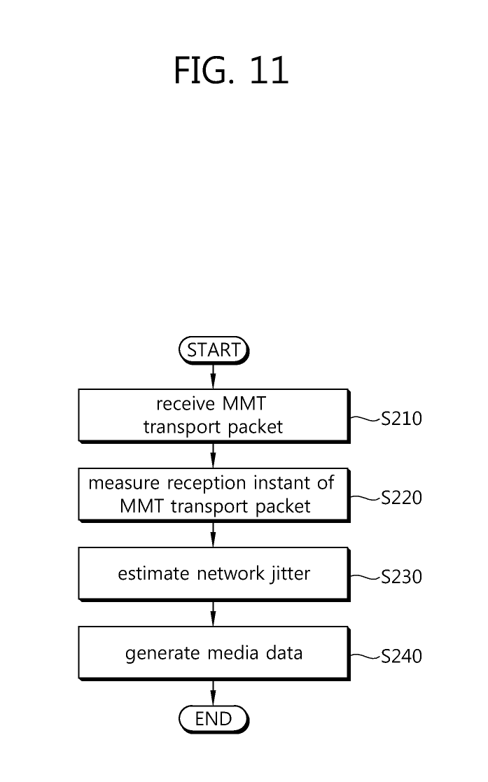

FIG. 11 is a view illustrating a sequential operation of the apparatus for receiving coded media data according to an embodiment of the present invention. First, the reception unit 210 receives an MMT transport packet (S210). Next, the reception unit 210 or the network jitter estimation unit 220 measures a reception instant of the MMT transport packet (S220). Thereafter, the network jitter estimation unit 220 may estimate network jitter by using the measured reception instant of the MMT transport packet and the delivery instant of the MMT transport packet included in the MMT transport packet (S230). The operation of estimating network jitter may be terminated herein, and thereafter, a following process according to the coded media data reception may be performed. For example, the media data generation unit 230 may generate media data by using the MMT transport packet (S240).

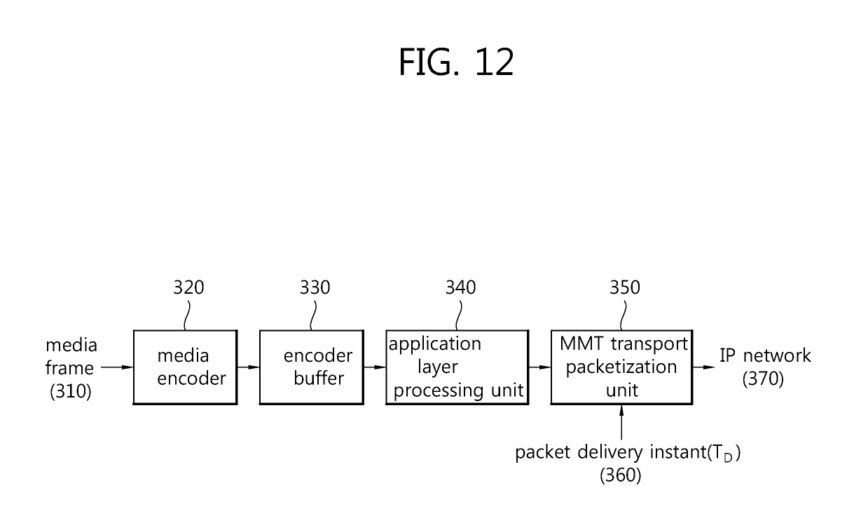

FIG. 12 is a functional block diagram of the apparatus for transporting coded media data according to an embodiment of the present invention. A media frame 310 is introduced to a media encoder 320. Here, the media frame may be a media picture. Upon receiving the media frame 310, the media encoder 320 codes the media frame 310. The media encoder 320 delivers the coded media frame to an encoder buffer 330, and the encoder buffer 330 temporarily stores the coded media frame received from the media encoder 320 and delivers the coded media data to an application layer processing unit 340 according to a transfer rate of the media data. The encoder buffer 330 may deliver the stored coded media frame to the application layer processing unit 340 under the control of the application layer processing unit 340 or under a separate control. The application layer processing unit 340 may performing processing such as AL-FEC, interleaving, or the like, on the coded media frame, and deliver the same to an MMT transport packetization unit 350. The MMT transport packetization unit 350 may generate an MMT transport packet by including a packet delivery instant Td 360 therein. The packet delivery instant may be generated and included in the MMT transport packet in a stage immediately before the MMT transport packet is transported, or a value obtained by estimating an instant at which the MMT transport packet is to be delivered may be delivered. Alternatively, an MMT transport packet delivery unit may insert a delivery instant into the MMT transport packet when it delivers the MMT transport packet. The MMT transport packet generated by the MMT transport packetization unit 350 is delivered via the IP network 370.

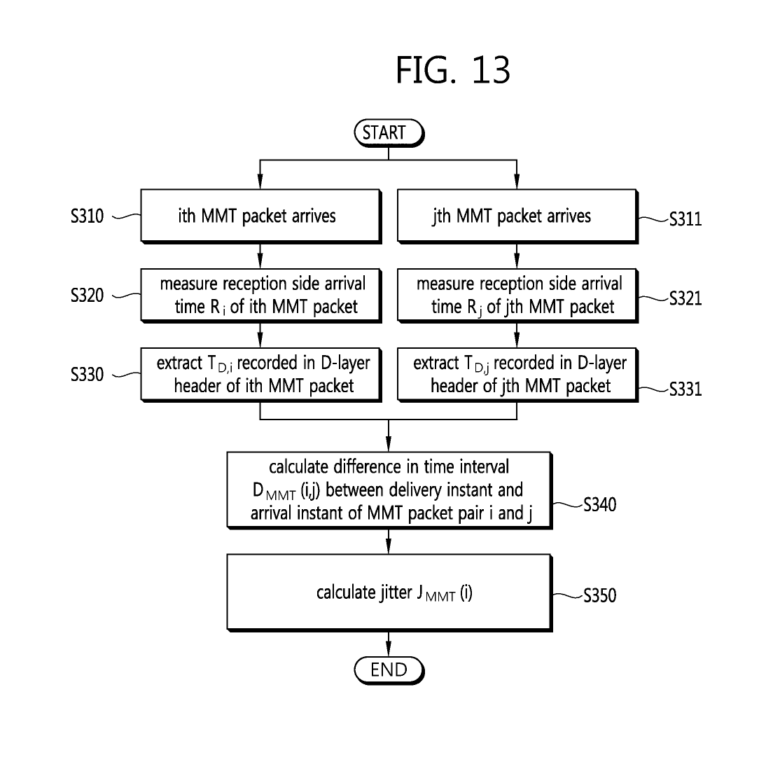

FIG. 13 is a flow chart illustrating a method for estimating network jitter in a system for transporting coded media data according to an embodiment of the present invention. First, ith MMT transport packet arrives (S310). Next, a reception side arrival instant Rᵢ of the ith MMT transport packet is measured (S320). A T_{D,I} value recorded in a header of the ith MMT transport packet layer is extracted (S330). During steps S310, S320, and S330, jth MMT transport packet may arrive (S311). When the jth MMT transport packet arrives, a reception side arrival instant Rⱼ of the jth MMT transport packet is measured (S321). Thereafter, a T_{D,j} value recorded in a header of a transport layer of the jth MMT transport packet is extracted (S331). Steps S310, S320, and S330 of the ith packet and steps S311, S321, and S331 of the jth packet may be performed in parallel.

Thereafter, a difference D_{MMT}(i,j) in time interval between delivery instants and arrival instants of the MMT transport packets is calculated (S340). D_{MMT}(i,j) may be calculated by using Equation 3 as described above. Thereafter, jitter J_{MMT}(i) between arrivals defined by mean dispersion of the differences in the packet intervals is calculated (S350). Jitter J_{MMT}(i) may be calculated by using Equation 4 as described above.

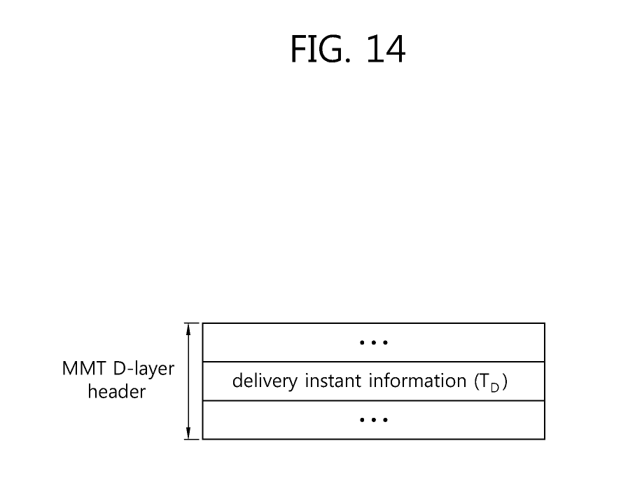

An embodiment in which delivery instant information is expressed in an MMT transport packet header will be described. FIG. 14 is a view illustrating a header structure of an MMT transport packet according to an embodiment of the present invention. As illustrated in FIG. 14, a header of an MMT transport packet may indicate an instant at which an MMT transport packet is delivered by including delivery instant information (T_{D}) field.

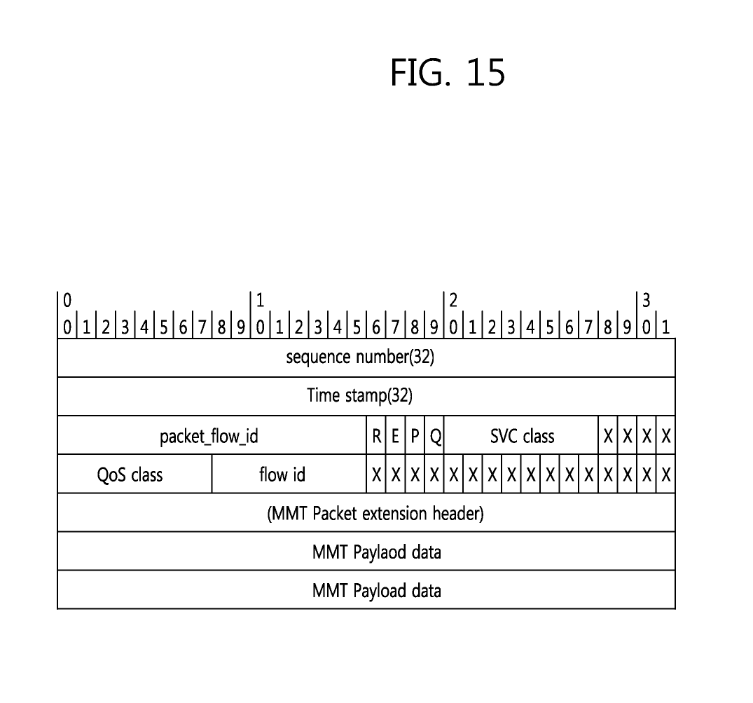

FIG. 15 is a view illustrating a header structure of an MMT transport packet according to an embodiment of the present invention. As illustrated in FIG. 15, an MMT transport packet may include sequence number, time stamp, a field indicating attributes such as packet_flow_id, svc class, QoS class, flow id, and the like, and MMT payload data. Timestamp may indicate an instant at which an MMT transport packet is delivered.

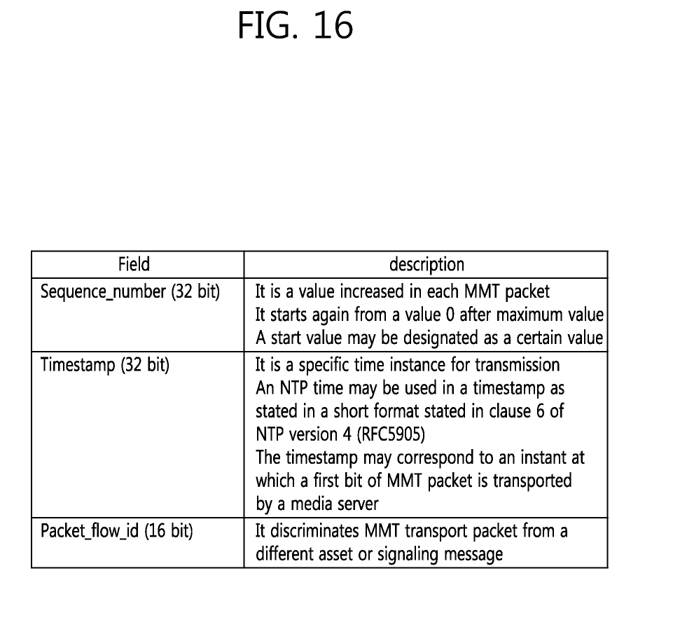

FIG. 16 is a view illustrating semantics of an MMT transport packet header according to an embodiment of the present invention. Description of some of fields indicating attributes of an MMT transport packet in an MMT transport packet header is illustrated. A sequence_number field expressed by 32 bits may indicate a sequence number of each MMT transport packet. Sequence number (sequence_number) may have a value increasing for each MMT transport packet, and when it has a maximum value, a sequence number of a next MMT transport packet may have a value 0. A start value of the sequence number may be a certain value.

A timestamp field may be expressed by 32 bits, as a specific time instance used for transporting an MMT transport packet. An NTP time may be used in the timestamp as stated in a short format stated in clause 6 of NTP version 4 (RFC5905). The timestamp may correspond to an instant at which a first bit of an MMT transport packet is transported by a media server

The packet_flow_id field is expressed by 16 bits, which allows an MMT transport packet to be discriminated from a different asset or signaling message.

1. A method for transporting media data in an apparatus for transporting coded media data, the method comprising:
generating an MMT transport packet by using a timestamp indicating an instant at which coded media data and the MMT transport packet are transported.

2. The method of claim 1, further comprising:
receiving a media fragment unit (MFU) having a format agnostic to a particular media codec from a media codec layer;
generating a media processing unit (MPU) by using the MFU;
encapsulating the generated MPU to generate an MMT asset;
encapsulating the generated MMT asset to generate an MMT package; and
receiving the generated MMT package and generating MMT payload,
wherein in the generating of the MMT transport packet, the MMT transport packet is generated by using the MMT payload.

3. The method of claim 1, wherein the timestamp indicates an instant at which a first bit of the MMT transport packet is to be transported.

4. The method of claim 3, further comprising: transporting the MMT transport packet.

5. An apparatus for transporting media data for transporting coded media data, the apparatus comprising:
an MMT transport packet generation unit configured to generate an MMT transport packet by using a timestamp indicating an instant at which coded media data and the MMT transport packet are to be transported.

6. The apparatus of claim 5, further comprising:
a media fragment generation unit receiving a media fragment unit (MFU) having a format agnostic to a particular media codec from a media codec layer;
a media processing unit (MPU) generation unit configured to generate an MPU by using the MFU;
an MMT asset generation unit configured to encapsulate the generated MPU to generate an MMT asset;
an MMT package generation unit configured to encapsulate the generated MMT asset to generate an MMT package;
an MMT payload generation unit configured to receive the generated MMT package and generate MMT payload,
wherein the MMT transport packet generation unit generates an MMT transport packet by using the MMT payload and the timestamp.

7. The apparatus of claim 5, wherein the MMT transport packet generation unit stores the timestamp in a head part of the MMT transport packet.

8. The apparatus of claim 5, wherein the timestamp indicates an instant at which a first bit of the MMT transport packet is to be transported.

9. The apparatus of claim 8, further comprising: a delivery unit configured to deliver the MMT transport packet.

10. A method for estimating network jitter in an apparatus for receiving coded media data, the method comprising:
calculating network jitter by using a time stamp generated in an MMT transport packet, by an MMT transport packet generation unit of a media data transporting apparatus, to indicate an instant at which media data is transported and an instant at which the media data is received by the media data receiving apparatus.

11. The method of claim 10, wherein the method for estimating network jitter further comprising:
receiving, by the media data receiving apparatus, the MMT transport packet; and
obtaining, by the media data receiving apparatus, an instant at which the MMT transport packet was received,
wherein the instant at which the media data was received is an instant at which the MMT transport packet was received.

12. The method of claim 10, wherein the timestamp indicates an instant at which a first bit of the MMT transport packet was transported from the media data transporting apparatus.

13. The method of claim 10, wherein in the calculating of network jitter, jitter values are iteratively calculated to be updated by using a time difference between a delivery instant and a reception instant of at least one received MMT transport packet.

14. The method of claim 13, wherein in the calculating of network jitter, network jitter is calculated by using J_{MMT}(i)=J_{MMT}(i−1)+(|D_{MMT}(i−1,i)|−J_{MMT}(i−1))/16, wherein D_{MMT}(i, j) indicates a difference in time interval between a delivery instant and a reception instant of MMT transport packets i and j, and J_{MMT}(i) indicates network jitter of ith transport packet.

15. The method of claim 13, wherein the difference in time interval between the delivery instant and the reception instant is calculated by subtracting a difference between a delivery instant of a first MMT transport packet and a second MMT transport packet from a difference between a reception instant of the first MMT transport packet and a reception instant of the second MMT transport packet.

16. An apparatus for estimating network jitter in an apparatus for receiving coded media data, the apparatus comprising:
a network jitter estimating unit configured to calculate network jitter by using a time stamp generated by an MMT transport packet generation unit of a media data transporting apparatus in an MMT transport packet to indicate an instant at which media data is transported and an instant at which the media data was received by the media data receiving apparatus.

17. The apparatus of claim 16, further comprising: a reception unit configured to receive the MMT transport packet and obtaining an instant at which the MMT transport packet was received.

18. The apparatus of claim 16, wherein the time stamp indicates an instant at which a first bit of the MMT transport packet was transported from the media data transporting apparatus.

19. The apparatus of claim 16, wherein the network jitter estimating unit iteratively calculates and updates jitter values by using a time difference between the delivery instant and the reception instant.

20. The apparatus of claim 19, wherein the network jitter estimating unit calculates network jitter by using J_{MMT}(i)=J_{MMT}(i−1)+(|D_{MMT}(i−1,i)|−J_{MMT}(i−1))/16, wherein D_{MMT}(i, j) indicates a difference in time interval between a delivery instant and a reception instant of MMT packets i and j, and J_{MMT}(i) indicates network jitter of ith transport packet.

21. The apparatus of claim 19, wherein the difference in time interval between the delivery instant and the reception instant is calculated by subtracting a difference between a delivery instant of a first MMT transport packet and a second MMT transport packet from a difference between a reception instant of the first MMT transport packet and a reception instant of the second MMT transport packet.

22. An MMT transport packet structure used for transporting coded media data comprises:
a time stamp generated by an MMT transport packet generation unit of a coded media data transporting apparatus to indicate time information of an instant at which an MMT transport packet is transported.

23. The MMT transport packet structure of claim 22, wherein the time stamp indicates an instant at which a first bit of the MMT transport packet was transported by the media data transporting apparatus.
